(19) United States
(12) Patent Application Publication
(10) Pub. No.: US 2016/0176116 A1
(43) Pub. Date: Jun. 23, 2016

(54) APPARATUS AND METHOD FOR AUTHORING THREE-DIMENSIONAL OBJECT FOR THREE-DIMENSIONAL PRINTING

(71) Applicant: Electronics and Telecommunications Research Institute, Daejeon (KR)

(72) Inventors: Bon Woo HWANG, Daejeon (KR); Seung Uk YOON, Daejeon (KR); Seong Jae LIM, Daejeon (KR); Hye Ryeong JUN, Daejeon (KR); Jin Sung CHOI, Daejeon (KR)

(21) Appl. No.: 14/962,110

(22) Filed: Dec. 8, 2015

(30) Foreign Application Priority Data
Dec. 17, 2014 (KR) 10-2014-0182386

(51) Int. Cl. B29C 67/00; G05B 19/4099; G06T 17/20

(52) U.S. Cl. CPC B29C 67/0088; G06T 17/20; G05B 19/4099; G05B 2219/35134; G05B 2219/49007; B33Y 50/02

(57) ABSTRACT

Provided is a three-dimensional (3D) object authoring apparatus for 3D printing. In the three-dimensional (3D) object authoring apparatus, a plurality of example objects having design components desired by a user may be created from a small number of previously created initial example objects by using a mesh deformation method in a nonlinear feature space. The 3D object desired by a user may be created by linearly composing example objects, having design components desired by the user, among a plurality of previously created example object.

### CROSS-REFERENCE TO RELATED APPLICATIONS

This application claims priority under 35 U.S.C. §119 to Korean Patent Application No. 10-2014-0182386, filed on Dec. 17, 2014, the disclosure of which is incorporated herein by reference in its entirety.

### TECHNICAL FIELD

The present invention relates to an apparatus and method for authoring a three-dimensional (3D) object for 3D printing, and more particularly, to a 3D object authoring apparatus and method based on an example.

### BACKGROUND

3D printing technology is technology that produces a 3D-shaped object by stacking thin layers according to shape information of a 3D model.

The 3D printing technology may be divided into an a 3D object authoring operation of authoring an object, which is to be created by a user, in a 3D shape, a printing operation of actually forming a detailed shape of the authored 3D object, and a finishing operation of surface-processing the created object.

In the 3D printing operations, the 3D object authoring operation may scan a desired object by using a 3D scanner, create a 3D object by using 3D modeling software, or use a 3D object scanned or created by a third person.

Since the 3D scanner is expensive equipment, an economic burden is too large for general users to create a 3D object for 3D printing by using the 3D scanner.

Moreover, creating a 3D object for 3D printing by using the 3D modeling software is an operation which is very difficult for general users except skilled expert designers.

Moreover, a preference of a user is not reflected in an operation of creating a 3D object for 3D printing by using a 3D object scanned or created by a third person as-is.

Face expression animation technology, which generates various face expressions by using face expression examples which have been previously created in association with creation of a 3D object, is not the field of 3D printing technology, but is being researched and developed.

In the face expression animation technology, various face expressions in which a preference of a user is reflected are generated by linearly composing a plurality of previously created face expression examples.

In such a method, however, since nonlinear deformation such as a rotation component and/or the like occurs in a 3D computer graphic processing of giving various design components to an object a complicated joint structure or a long protrusion like arms and legs of persons, it is difficult to author a complicated 3D object by linearly composing merely a plurality of example objects.

To overcome the limitations, a 3D object authoring method using a nonlinear deformation method in a nonlinear feature space may be considered.

In the 3D object authoring method using the nonlinear deformation method, it is possible to process nonlinear deformation of an object, but as a complexity of a mesh and the number of example objects increase, a calculation time taken in creating a new object increases drastically. For this reason, the 3D object authoring method has a limitation in real-time processing.

### SUMMARY

Accordingly, the present invention provides a 3D object authoring apparatus and method, which author a 3D object for 3D printing in real time.

In one general aspect, a 3D object authoring apparatus for 3D printing includes: an initial example object creating unit configured to set design components in example objects, allocate a feature value, which is capable of being expressed in a nonlinear feature space, to the example objects in which the design components are set, and create the example objects, to which the feature value is allocated, as initial example objects; an extension example object creating unit configured to subdivide the feature value allocated to the initial example objects and create extension example objects having the subdivided feature values; and a user object creating unit configured to receive an arbitrary feature value of a design component desired by a user, search for a space including the arbitrary feature value in the nonlinear feature space, select extension example objects corresponding to vertices constituting a found space, apply weight values to feature values of the selected extension example objects, and linearly compose the feature values of the extension example objects, to which the weight values are applied, to create a user object (or a 3D object) having the linearly composed feature values.

In another general aspect, a 3D object authoring method for 3D printing includes: setting design components in example objects; allocating a feature value, which is capable of being expressed in a nonlinear feature space, to the example objects in which the design components are set, and creating the example objects, to which the feature value is allocated, as initial example objects; subdividing the feature value allocated to the initial example objects and creating extension example objects having the subdivided feature value; receiving an arbitrary feature value of a design component desired by a user and searching for a space including the arbitrary feature value in the nonlinear feature space; and selecting extension example objects corresponding to vertices constituting a found space, applying weight values to feature values of the selected extension example objects, and linearly composing the feature values of the extension example objects, to which the weight values are applied, to create a user object (or a 3D object) having the linearly composed feature values.

Other features and aspects will be apparent from the following detailed description, the drawings, and the claims.

### BRIEF DESCRIPTION OF THE DRAWINGS

FIG. 1 is a block diagram illustrating an example-based 3D object authoring apparatus for 3D printing according to an embodiment of the present invention.

FIG. 2 is a diagram illustrating an example of a plurality of example objects created by an initial example object creating unit illustrated in FIG. 1.

FIG. 3 is a diagram for describing a thickness component among design components according to an embodiment of the present invention.

FIGS. 4A and 4B are diagrams illustrating an example where an initial example object, to which a feature value is allocated by the initial example object creating unit illustrated in FIG. 1, is marked on a feature vector space.

FIG. 5 is a diagram illustrating a feature vector space on which an extension example object which is allocated a feature value extended by an extension example object creating unit illustrated in FIG. 2 is marked.

FIG. 6 is a diagram illustrating a space including a feature value input by a user in a feature vector space.

FIG. 7 is a diagram showing a table in which a feature value of an extension example object, a feature value input by a user, and weight values calculated by a user object creating unit are listed.

FIG. 8 is a flowchart for describing a 3D object authoring method according to an embodiment of the present invention.

### DETAILED DESCRIPTION OF EMBODIMENTS

In this disclosure below, a plurality of example objects having design components desired by a user may be created from a small number of previously created initial example objects by using a mesh deformation method in a nonlinear feature space.

Moreover, in this disclosure below, a 3D object desired by a user may be created by linearly composing example objects, having design components desired by the user, among a plurality of previously created example object.

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

The terms used herein are for the purpose of describing particular embodiments only and are not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, embodiments of the present invention will be described in detail with reference to the accompanying drawings.

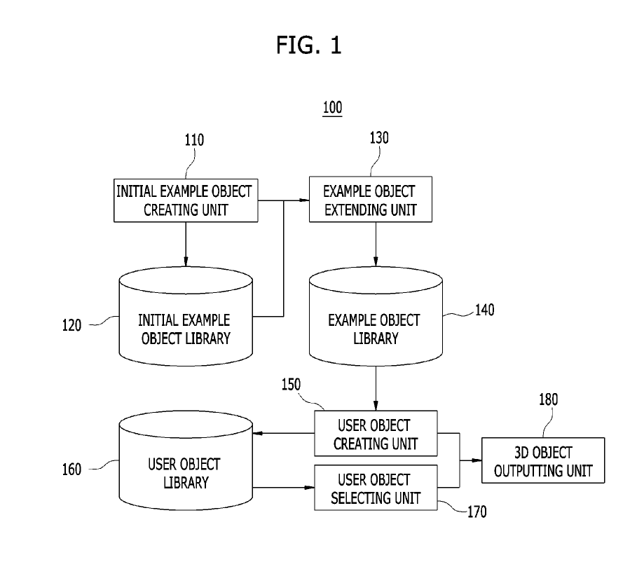

FIG. 1 is a block diagram illustrating an example-based 3D object authoring apparatus 100 for 3D printing according to an embodiment of the present invention.

Referring to FIG. 1, the example-based 3D object authoring apparatus 100 for 3D printing according to an embodiment of the present invention may include an initial example object creating unit 110, an initial example object library 120, an example object extending unit 130, an example object library 140, a user object creating unit 150, a user object library 160, a user object selecting unit 170, and a 3D object outputting unit 180.

The initial example object creating unit 110 may include a user interface such as a keyboard, a mouse, an electronic pen, or the like and may receive, through the user interface, a plurality of example objects previously created by an expert designer.

The initial example object creating unit 110 may set design components in the example objects and may allocate feature values to the set design components. The feature values may be used as coordinates that enable the design components, set in the example objects, to be expressed in a nonlinear feature space or a feature vector space and will be described below in detail. The feature values may be referred to as mesh vertices.

The initial example object creating unit 110 may create example objects, to which the feature values are allocated, as initial example objects.

The initial example object library 120 may be an element that stores the initial example objects created by the initial example object creating unit 110, and may be implemented with a storage medium such as a memory, a hard disk, or the like.

The example object extending unit 130 may extend the feature values allocated to the initial example objects to create extension example objects, based on a nonlinear deformation method in nonlinear feature space using deformation gradients.

The nonlinear deformation method is disclosed in detail in the paper “Mesh-Based Inverse Kinematics” published in ACM Trans. Graph by R. W. Sumner, M. Zwicker, C. Gotsman, and J. Popovic in 2005, and thus, its detailed description is not provided.

The example object library 140 may be a storage medium that stores the feature values of the extension example objects created by the example object extending unit 130, and the storage medium may be a memory, a hard disk, or the like.

The user object creating unit 150 may receive arbitrary feature values of design components desired by a general user and may linearly compose the feature values (or mesh vertices) of the extension example objects stored in the example object library 140 to create (or author) a new user object to which design components desired by the general user are given.

The user object library 160 may be an element that stores the user object (or a 3D object) created by the user object creating unit 150, and the storage medium may be a memory, a hard disk, or the like.

The user object selecting unit 170 may select a user object, for which 3D printing is to be performed by the user, from among user objects stored in the user object library 160 according to a user input which is received through a user interface such as a keyboard, a mouse, an electronic pen, a touch display device, or the like.

The 3D object outputting unit 180 may be an element that outputs the user object created by the user object creating unit 150 or selected by the user object selecting unit 170, and may be a 3D printer. The 3D printer may be connected to the user object creating unit 150 or the user object selecting unit 170 by wire or wirelessly.

Hereinafter, main elements of the 3D object authoring apparatus illustrated in FIG. 1 will be described in more detail.

Initial Example Object Creating Unit 110

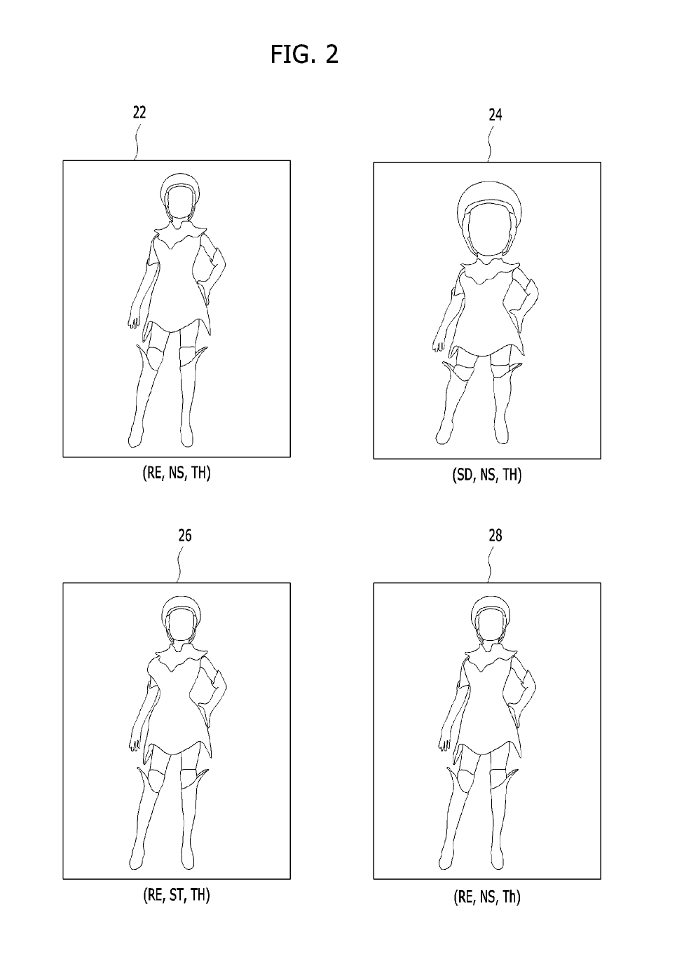

FIG. 2 is a diagram illustrating an example of a plurality of example objects created by the initial example object creating unit illustrated in FIG. 1.

Referring to FIG. 2, as described above, the initial example object creating unit 110 may set design components in example objects created by an expert. In the present embodiment, the design components may include a proportion component, a style component, and a thickness component.

The proportion component may include a REgular (RE) component and a Super Deformed (SD) component which is an opposite component of the RE component.

The RE component may be a component representing a regular proportion or a standard proportion of each of the example objects, and the SD component may be a component representing a deformed proportion at which a regular proportion or a standard proportion of an object is inordinately deformed.

The style component may include a Non-Style (NS) component and a STyle (ST) component that is an opposite component of the NS component.

The style component may be a component representing a style of each of the example objects. When the example object is a person, the style component may be a component representing masculinity or femininity of a human body such as a chest, a waist, a hip, a stomach, or the like.

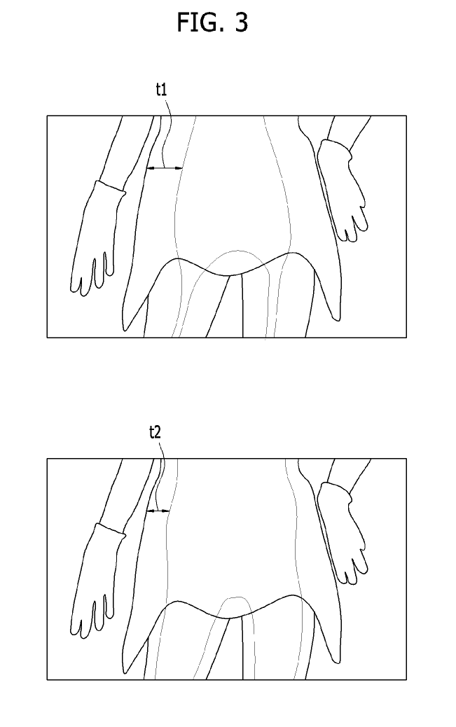

The thickness component may include a THick (TH) component and a Thin (Th) component that is an opposite component of the TH component. Here, as illustrated in FIG. 3, the thickness component may denote each of thicknesses “t1” and “t2” of 3D printed matters which are actually output by the 3D printer.

The initial example object creating unit 110 may classify the example objects into a reference object 22 and other objects 24, 26 and 28 and may set the proportion component, the style component, and the thickness component to each of the classified objects. The reference object 22 may be an object that becomes a reference of deformation.

In detail, the RE component, the NS component, and the TH component may be set in the reference object 22, and the components set in the reference object 22 may be reference components.

The proportion component, the style component, and the thickness component may be set in each of the other objects 24, 26 and 28. An opposite component of one of components included in the reference component may be set in each of the other objects 24, 26 and 28.

That is, the SD component, the NS component, and the TH component may be set in the object 24, and the RE component, the ST component, and the TH component may be set in the object 26. Also, the RE component, the NS component, and the Th component may be set in the object 28.

As described above, according to an embodiment of the present invention, since the initial example object creating unit 110 create an initial example object (or a reference object), having the reference component which includes the RE component, the NS component, and the TH component, and another initial example object having an opposite component of one of the RE component, the NS component, and the TH component, the initial example object creating unit 110 may create a total of four initial example objects. Therefore, according to an embodiment of the present invention, when the number of design components is P (where P is a positive integer number), the initial example object creating unit 110 may create P+1 initial example objects.

When four initial example objects 22, 24, 26 and 28 in which design components are set are created, feature values may be allocated to the set design components.

In an embodiment, the feature values may include 1 and −1. In this case, a feature value “1” may be allocated to the RE component, the NS component, and the TH component representing the reference component, and a feature value “−1” may be allocated to an opposite component thereof.

Therefore, since the reference component is set in the reference object 22, a feature value allocated to the reference object 22 may be (1, 1, 1).

Since the design components including the RE component, the NS component, and the TH component are set in the object 24, a feature value allocated to the design components of the object 24 may be (−1, 1, 1).

Similarly, a feature value allocated to the design components of the object 26 may be (1, −1, 1), and a feature value allocated to the design components of the object 28 may be (1, 1, −1).

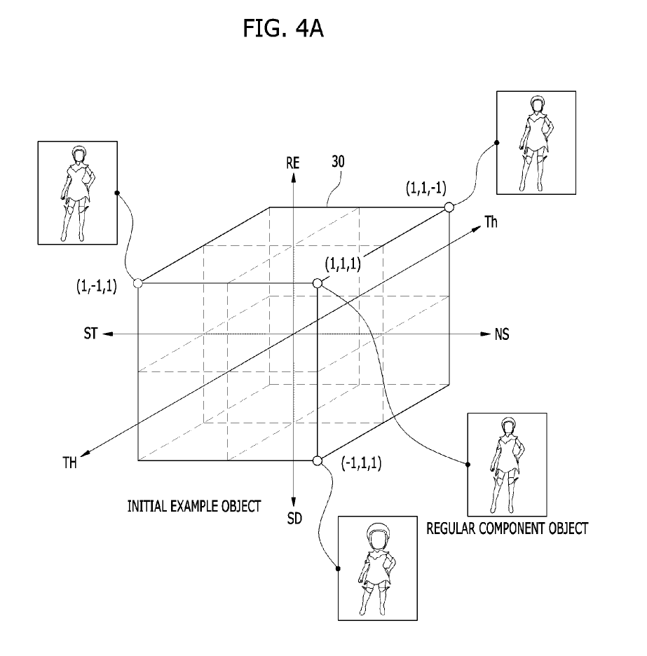

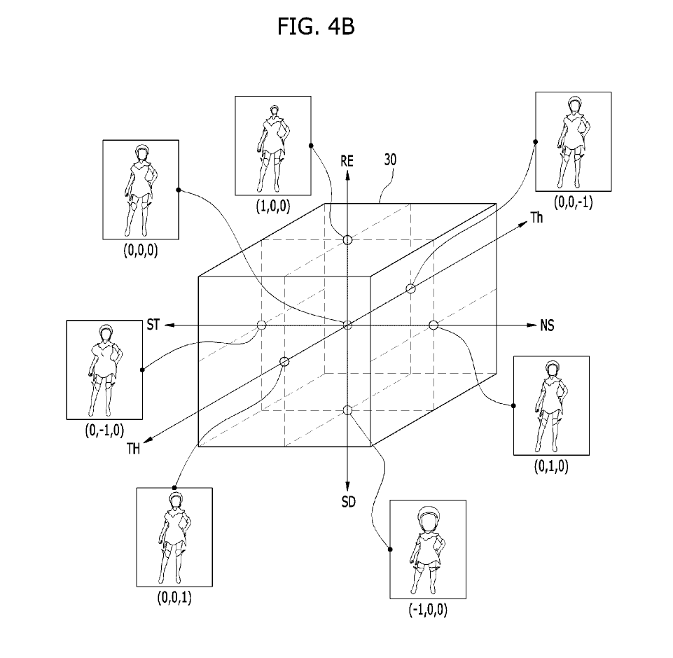

The feature values allocated to the respective design components of the objects 22, 24, 26 and 28 may be set to coordinate values representing a vertex of a feature vector space 30 on a 3D coordinate system illustrated in FIG. 4A.

In another embodiment, a reference object which becomes a reference of deformation may be set in an original point (0, 0, 0) of the feature vector space 30, and initial example objects whose design components are symmetrical with respect to the reference object set in the original point (0, 0, 0) may be marked on −1 and 1 of an axis constituting the feature vector space 30. In this case, unlike an embodiment of FIG. 4A, when the number of design components is P, the number of initial example objects may be “(2×P)+1”.

That is, as illustrated in FIG. 4B, when the number of design components is 3, the total number of initial example objects may be 7, and the initial example objects may be marked on an original point and a center point of a surface constituting a cube, instead of vertices of the cube constituting the feature vector space 30.

In another embodiment, as described above, the number of initial example objects marked on the feature vector space 30 may increase, but precise design components may be reflected in the initial example objects.

Example Object Extending Unit 130

The example object extending unit 130 may create an extension example object capable of being marked on the feature vector space 30 by using the mesh deformation method in the nonlinear feature space.

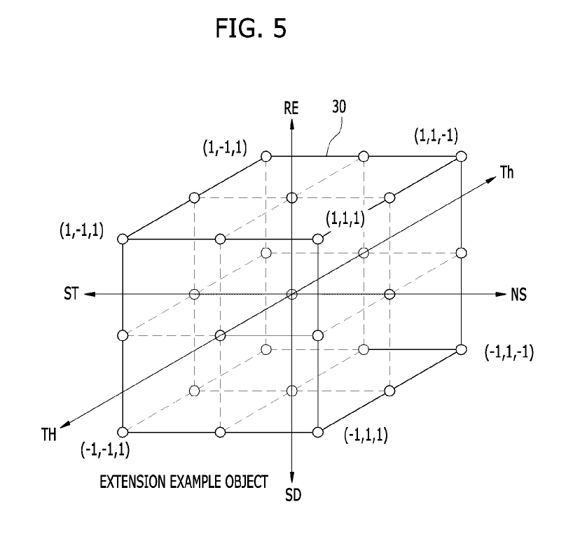

Referring to FIG. 5, when the number of design components is n (where n is a positive integer number) and the number of feature values allocated to the design components is P, the number of extension example objects may be Pⁿ.

For example, when the number of design components is 3 and the number of feature values allocated to each of the design components is three “−1, 0 and 1”, the number of extension example objects may be 27 (=3³). Here, a feature value “−1” may be a value allocated to an opposite component of a design component to which a feature value “1” is allocated, and a feature value “0” may be a value allocated to an median component between a design component, to which the feature value “−1” is allocated, and the design component to which the feature value “1” is allocated.

When a degree of nonlinear deformation between initial example objects, having the RE component included in the proportion component, and an initial example object having the SD component included in the proportion component is large, the example object extending unit 130 may subdivide the feature values to increase the number of the feature values.

When an interval between feature values allocated to a specific design component is subdivided to 0.5, the initial example object creating unit 110 may extend two feature values “−1 and 1”, allocated to the specific design component, to five feature values “−1, −0.5, 0, 0.5 and 1”. In this case, the number of extension example objects may be 45 (=3×3×5).

The initial example object creating unit 110 may subdivide the allocated feature values to increase the number of the feature values, and thus, a degree of nonlinear deformation is reduced by the increased number of the feature values.

The created extension example objects may be directly used for creating a user object with a 3D authoring tool, and thus, an error may be corrected by manual work of an expert designer or by using error verification software for 3D printing.

User Object Creating Unit 150

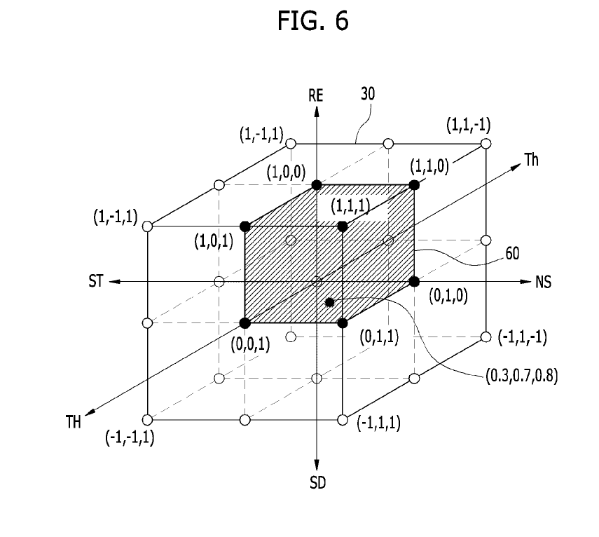

Referring to FIG. 6, the user object creating unit 150 may receive an arbitrary feature value representing a design component desired by the general user, detect a space (an obliquely-striped space in FIG. 6) 60 including the received arbitrary feature value in the feature vector space 30, and select extension example objects “(0, 0, 0), (0, 0, 1), (0, 1, 0), (0, 1, 1), (1, 0, 0), (1, 0, 1), (1, 1, 0) and (1, 1, 1)” respectively corresponding to vertices of a cube constituting the detected space 60.

The user object creating unit 150 may calculate weight vectors of feature values of the selected extension example objects “(0, 0, 0), (0, 0, 1), (0, 1, 0), (0, 1, 1), (1, 0, 0), (1, 0, 1), (1, 1, 0) and (1, 1, 1)”, based on a linear programming method or a quadratic programming method.

Here, a range of an absolute value (hereinafter referred to as a weight value) of each of the weight vectors may be 0 to 1, and a total sum of weight values of the selected extension example objects may be limited to 1.

As described above, since a range of a weight value is limited, an object which is created from feature values of design components input by the user may be created through only interpolation of extension example objects which have been verified by an expert designer or by using error verification software for 3D printing. This is a very important factor for guaranteeing completeness of an authored user object.

When a weight vector is acquired, the user object creating unit 150 may apply weight values to the feature values of the selected extension example objects and may create a new user object by linearly composing the feature values to which the weight values are applied.

That is, the user object creating unit 150 may constitute a vertex matrix by applying a weight vector including weight values to mesh vertices expressed as the feature values of the selected extension example objects and may generate the new user object by linearly composing the vertex matrix.

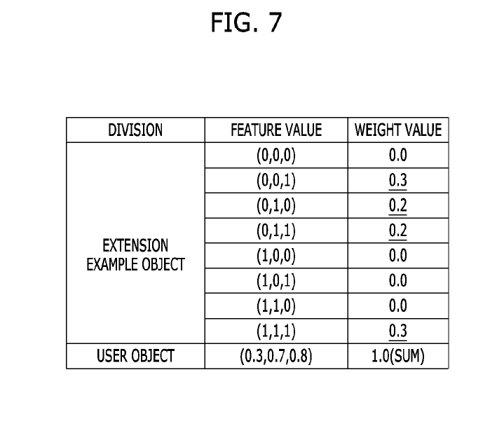

FIG. 7 shows a table listing the feature values of the extension example objects, a feature value of a user object input by a user, and weight values calculated based on the linear programming method or the quadratic programming method having the limitation conditions for example.

As shown in FIG. 7, each of the calculated weight values may have 0 to 1, and a sum of the weight values may be 1 (=0.3+0.2+0.2+0.3).

“0.3*(0, 0, 1)+0.2*(0, 1, 0)+0.2*(0, 1, 1)+0.3*(1, 1, 1)=(0.3, 0.7, 0.8)” may be calculated by linearly composing the feature values of the extension example objects, based on the calculated weight values.

Since the user object creating unit 150 according to an embodiment of the present invention selects eight extension example objects located on vertices of a specific space and creates a user object by linearly composing only a vertex matrix of selected extension example objects, the number of arithmetic operations is reduced. This denotes that a user object is obtained in real time or in semi-real time.

User Object Library 160

The user object library 160 may store the weight value applied to each of the extension example objects and the user objects created by the user object creating unit 150.

User Object Selecting Unit 170

The user object selecting unit 170 may display the user objects, created by the user object creating unit 150, in a display device and may selectively output a user object desired by the user according to a user input.

In the present embodiment, it has been described above that the user object creating unit 150 performs an arithmetic operation of linearly composing the mesh vertex constituting the extension example objects by using the weight vectors stored in the user object library 160, but the arithmetic operation may be performed by the user object selecting unit 170 without being limited thereto. In this case, the user object creating unit 150 and the user object selecting unit 170 may be implemented as one functional block, namely, one body.

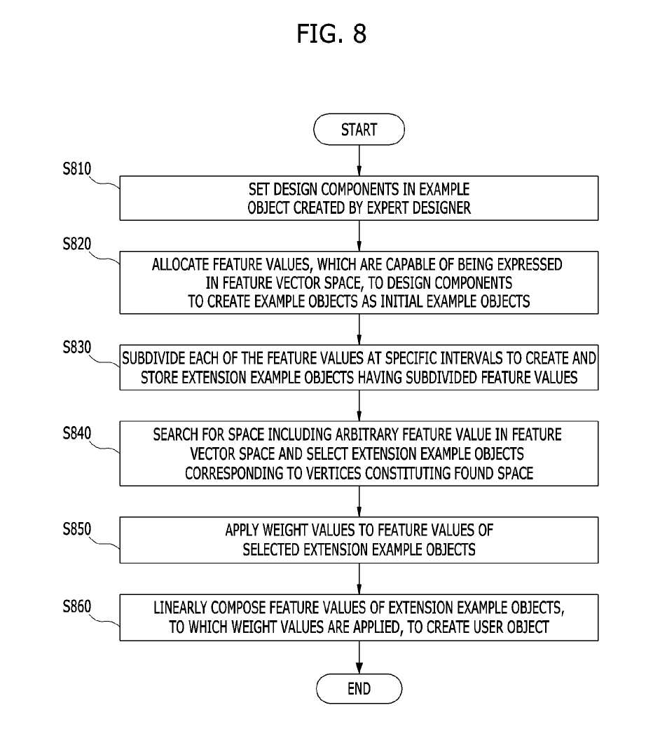

FIG. 8 is a flowchart for describing a 3D object authoring method according to an embodiment of the present invention. To help understand description, FIG. 1 will be referred to together.

Referring to FIG. 8, first, in step S810, the initial example object creating unit 110 may receive example objects created by an expert designer and may set the design components in the example objects according to a user input.

Subsequently, in step S820, the initial example object creating unit 110 may allocate feature values, which is capable of being expressed in a feature vector space, to the set design component to create example objects, to which the feature values are allocated, as initial example objects and may store the created initial example object in the initial example object library 120.

Subsequently, in step S830, the example object extending unit 130 may subdivide each of the feature values allocated to the initial example objects at specific intervals to create extension example objects having the subdivided feature values (or a subdivided design component) and may store the created extension example objects in the example object library 140.

Subsequently, in step S840, the user object creating unit 150 may receive an arbitrary feature value of a design component desired by a general user, may search for a space including the arbitrary feature value in the feature vector space, and may select extension example objects corresponding to vertices constituting a found space.

Subsequently, in step S850, the user object creating unit 150 may apply weight values (a weight vector) to feature values of the selected extension example objects.

Subsequently, in step S860, the user object creating unit 150 may linearly compose the feature values of the extension example objects, to which the weight values are applied, to create a user object having the linearly composed feature value.

As described above, according to the embodiments of the present invention, a plurality of example objects having various state changes of desired design components may be previously created from a small number of initial example objects created by an expert designer, based on the mesh deformation method in the nonlinear feature space using deformation gradients.

Moreover, according to the embodiments of the present invention, extension example objects associated with feature values of design components desired by a user may be selected, weight values may be applied to feature values of the selected extension example objects, and the feature values to which the weight values are applied may be linearly composed, thereby authoring an object having a desired shape in real time.

Moreover, according to the embodiments of the present invention, a user authors in real time a 3D object for 3D printing through simple manipulation.

An embodiment of the present invention may be implemented in a computer system, e.g., as a computer readable medium. A computer system may include one or more of a processor, a memory, a user input device, a user output device, and a storage, each of which communicates through a bus. The computer system may also include a network interface that is coupled to a network. The processor may be a central processing unit (CPU) or a semiconductor device that executes processing instructions stored in the memory and/or the storage. The memory and the storage may include various forms of volatile or non-volatile storage media. For example, the memory may include a read-only memory (ROM) and a random access memory (RAM). Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

When the embodiments of the present invention are applied to a computer system such as a computer-readable recording medium, the initial example object creating unit 110, the extension example object creating unit 130, and the user object creating unit 150 illustrated in FIG. 1 may each be implemented as a logic provided in a processor.

The 3D object authoring method for 3D printing according to the embodiments of the present invention is not limited to the above-described details, and all or some of the embodiments may be selectively combined and configured so as to realize various modifications.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A three-dimensional (3D) object authoring apparatus for 3D printing comprising:
an initial example object creating unit configured to set design components in example objects, allocate feature values, which is capable of being expressed in a nonlinear feature space, to the example objects in which the design components are set, and create the example objects, to which the feature values are allocated, as initial example objects;
an extension example object creating unit configured to subdivide the feature values allocated to the initial example objects and create extension example objects having the subdivided feature values; and
a user object creating unit configured to receive an arbitrary feature value of a design component desired by a user, search for a space including the arbitrary feature value in the nonlinear feature space, select extension example objects corresponding to vertices constituting a found space, apply weight values to feature values of the selected extension example objects, and linearly compose the feature values of the extension example objects, to which the weight values are applied, to create a user object (or a 3D object) having the linearly composed feature values.

2. The 3D object authoring apparatus of claim 1, wherein
the initial example object creating unit sets the design components, including a proportion component, a style component, and a thickness component, in the example objects,
the proportion component is a component representing a regular proportion of each of the example objects and comprises a REgular (RE) component and a Super Deformed (SD) component that is an opposite component of the RE component,
the style component is a component representing masculinity or femininity of each of the example objects and comprises a Non-Style (NS) component and a STyle (ST) component that is an opposite component of the NS component, and
the thickness component is a component representing a thickness of an output matter which is actually output through the 3D printing, and comprise a THick (TH) component and a Thin (Th) component that is an opposite component of the TH component.

3. The 3D object authoring apparatus of claim 2, wherein the initial example object creating unit classifies the example objects into a reference object sets the RE component, the ST component, and the TH component in the reference object, and each of the other objects sets an opposite component of one of the RE component, the ST component, and the TH component which are set in the reference object.

4. The 3D object authoring apparatus of claim 2, wherein the initial example object creating unit allocates a feature value “1” to the RE component, the NS component, and the TH component and allocates a feature value “−1” to the SD component, the ST component, and the Th component.

5. The 3D object authoring apparatus of claim 1, wherein when number of the design components is P (where P is a positive integer number), the initial example object creating unit creates P+1 initial example objects.

6. The 3D object authoring apparatus of claim 2, wherein the extension example object creating unit subdivides the feature values allocated to the initial example objects at predetermined intervals to extend the feature values allocated to the initial example objects.

7. The 3D object authoring apparatus of claim 1, wherein when number of the design components is n (where n is a positive integer number) and number of feature values allocated to each of the n design components is P (where P is a positive integer number), the extension example object creating unit creates Pⁿ extension example objects.

8. The 3D object authoring apparatus of claim 1, wherein the user object creating unit linearly composes the feature values to which the weight values are applied, based on a linear programming method or a quadratic programming method.

9. The 3D object authoring apparatus of claim 8, wherein
the weight value calculated by the user object creating unit is 0 to 1, and
a total sum of weight values calculated based on the extension example objects is 1.

10. A three-dimensional (3D) object authoring method for 3D printing comprising:
setting design components in example objects;
allocating feature values, which is capable of being expressed in a nonlinear feature space, to the example objects in which the design components are set, and creating the example objects, to which the feature values are allocated, as initial example objects;
subdividing each of the feature values allocated to the initial example objects and creating extension example objects having the subdivided feature values;
receiving an arbitrary feature value of a design component desired by a user and searching for a space including the arbitrary feature value in the nonlinear feature space; and
selecting extension example objects corresponding to vertices constituting a found space, applying weight values to the feature values of the selected extension example objects, and linearly composing the feature values of the extension example objects, to which the weight values are applied, to create a user object (or a 3D object) having the linearly composed feature values.

11. The 3D object authoring method of claim 10, wherein
the setting of the design components comprises setting the design components, including a proportion component, a style component, and a thickness component, in the example objects,
the proportion component is a component representing a regular proportion of each of the example objects and comprises a REgular (RE) component and a Super Deformed (SD) component that is an opposite component of the RE component,
the style component is a component representing masculinity or femininity of each of the example objects and comprises a Non-Style (NS) component and a STyle (ST) component that is an opposite component of the NS component, and
the thickness component is a component representing a thickness of an output matter which is actually output through the 3D printing, and comprise a THick (TH) component and a Thin (Th) component that is an opposite component of the TH component.

12. The 3D object authoring method of claim 11, wherein the setting of the design components comprises:
classifying the example objects into a reference object and other objects;
setting the RE component, the ST component, and the TH component in the reference object; and
setting, in each of the other objects, an opposite component of one of the RE component, the ST component, and the TH component which are set in the reference object.

13. The 3D object authoring method of claim 12, wherein the creating of the extension example objects comprises subdividing the feature values allocated to the initial example objects at predetermined intervals to extend the feature values allocated to the initial example objects.

14. The 3D object authoring method of claim 10, wherein the creating of the user object comprises linearly composing the feature values to which the weight values are applied, based on a linear programming method or a quadratic programming method.

15. The 3D object authoring method of claim 14, wherein
the weight value is 0 to 1, and
a total sum of weight values calculated based on the extension example objects is 1.

16. The 3D object authoring method of claim 10, wherein the creating of the initial example objects comprises, when number of the design components is P (where P is a positive integer number), creating P+1 initial example objects.

17. The 3D object authoring method of claim 10, wherein the creating of the extension example objects comprises, when number of the design components is n (where n is a positive integer number) and number of feature values allocated to each of the n design components is P (where P is a positive integer number), creating Pⁿ extension example objects.
